(19) United States
(12) Patent Application Publication
(10) Pub. No.: US 2015/0064989 A1
(43) Pub. Date: Mar. 5, 2015

(54) CONNECTION STRUCTURE FOR SCREW CLAMP TERMINAL

(71) Applicant: Yazaki Corporation, Tokyo (JP)

(72) Inventor: Hitoshi HIRASAWA, Makinohara-shi (JP)

(73) Assignee: YAZAKI CORPORATION, Tokyo (JP)

(21) Appl. No.: 14/472,693

(22) Filed: Aug. 29, 2014

(30) Foreign Application Priority Data
Sep. 3, 2013 (JP) 2013-181737

(51) Int. Cl. H01R 4/30

(52) U.S. Cl. CPC H01R 4/305
USPC 439/781

(57) ABSTRACT

An engagement projection having a convex conical surface is provided in an outer peripheral region of a bolt insertion hole in an electrical contact part of a terminal, while an engagement depression having a concave conical surface corresponding to the convex conical surface and capable of engaging with the engagement projection through the concave conical surface is provided on an inner surface of a head of a bolt disposed opposed to the engagement projection. The engagement projection and the engagement depression are engaged with each other during the fastening of the bolt.

### CROSS-REFERENCE TO RELATED APPLICATIONS

The present application claims priority to and incorporates by reference the entire contents of Japanese Patent Application No. 2013-181737 filed in Japan on Sep. 3, 2013.

### BACKGROUND OF THE INVENTION

1. Field of the Invention

The present invention relates to a connection structure for a screw clamp terminal applied to, for example, an electrical junction box and fastened by a bolt to be electrically connected to a bus bar.

2. Description of the Related Art

A conventional connection structure for a screw clamp terminal is known, for example, in Japanese Patent Application Laid-open No. 2010-28919.

Specifically, in the connection structure for a screw clamp terminal according to this patent literature, as illustrated in FIG. 6 and FIG. 7, a terminal 1 includes an electrical contact part 5 and a coupling section 6. The electrical contact part 5 is bifurcated approximately in the shape of letter U to form a bolt shaft insertion section 5a into which a shaft 3a of a bolt 3 is inserted. The electrical contact part 5 is fastened by a head 3b of the bolt 3 and a nut 4 thereby to establish electrical connection with a bus bar 2. The coupling section 6 stands upright in the shape of an arch formed by connecting the front ends of the bifurcated electrical contact part 5. The coupling section 6 has an opening formed as a bolt head insertion section 6a into which the head 3b of the bolt 3 is inserted. The coupling section 6 couples the front ends of the bifurcated electrical contact part 5 with each other to prevent expansion deformation caused at the front end side of the electrical contact part 5 due to torque action during bolt fastening (hereinafter abbreviated as “expansion deformation based on fastening torque action”).

However, the conventional connection structure for a screw clamp terminal causes problems such as increasing the size of the terminal 1 because of the formation of the coupling section 6 and increasing the number of production processes because of the complicated shape.

In the conventional connection structure for a screw clamp terminal, the connection of the terminal 1 requires positioning using the coupling section 6, for example, by providing a not-shown electrical junction box with a section for temporarily holding the terminal 1 with the coupling section 6 interposed in order to avoid connection failure between the terminal 1 and the bus bar 2 due to displacement based on the torque action during bolt fastening (hereinafter abbreviated as “connection failure based on the fastening torque action”). The connecting operation of the terminal 1 is thus cumbersome.

### SUMMARY OF THE INVENTION

The present invention is devised in view of such technical problems and aims to provide a connection structure for a screw clamp terminal that can eliminate positioning of the terminal for connection while reducing size increase and cost increase of the terminal.

It is an object of the present invention to at least partially solve the problems in the conventional technology.

According to one aspect of the present invention, a connection structure for a screw clamp terminal having an electrical contact part through which a bolt insertion hole penetratingly formed communicating with outside through a notch, a shaft of a bolt being inserted into the bolt insertion hole through the notch, a head of the bolt fastening the electrical contact part to a member to be connected to establish electrical connection, the connection structure includes an engagement projection provided in an outer peripheral region of the bolt insertion hole, the engagement projection having a convex conical surface; and an engagement depression provided on an inner surface of the head of the bolt and disposed opposed to the engagement projection, the engagement depression having a concave conical surface corresponding to the convex conical surface and being capable of engaging with the engagement projection through the concave conical surface, wherein the engagement projection and the engagement depression are engaged with each other during fastening of the bolt.

According to another aspect of the present invention, a connection structure for a screw clamp terminal having an electrical contact part through which a bolt insertion hole penetratingly formed communicating with outside through a notch, a shaft of a bolt being inserted into the bolt insertion hole through the notch, a nut being screwed onto the shaft to fasten the electrical contact part to a member to be connected to establish electrical connection, the connection structure includes an engagement projection provided in an outer peripheral region of the bolt insertion hole, the engagement projection having a convex conical surface; and an engagement depression provided on an inner surface of the nut and disposed opposed to the engagement projection, the engagement depression having a concave conical surface corresponding to the convex conical surface and being capable of engaging with the engagement projection through the concave conical surface, wherein the engagement projection and the engagement depression are engaged with each other during fastening of the nut.

During bolt fastening, because of the engagement structure of the engagement projection formed on the outer surface of the terminal (electrical contact part) and the engagement depression formed on the inner surface of the bolt head, the head of the bolt allows the electrical contact part to be pulled toward the bolt center and pushed down so as to suppress enlargement of the notch as the bolt is fastened (advanced).

The connection structure is also applicable to a structure in which a terminal is fastened (connected) to a member to be connected by tightening a nut rather than a bolt. Also in this case, the same operation effects as in the bolt fastening described above are achieved.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connection structure for a screw clamp terminal according to the present invention in a state before a terminal is slipped onto a bolt;

FIG. 2 is a cross-sectional view along line A-A in FIG. 1;

FIG. 3 is a perspective view illustrating the connection structure for a screw clamp terminal according to the present invention in a state in which the terminal is fastened;

FIG. 4 is a cross-sectional view along line B-B in FIG. 3;

FIG. 5 is a cross-sectional view corresponding to FIG. 4 illustrating a modification of the connection structure for a screw clamp terminal according to the present invention;

FIG. 6 is a perspective view illustrating a conventional connection structure for a screw clamp terminal in a state before a terminal is slipped onto a bolt; and

FIG. 7 is a cross-sectional view corresponding to FIG. 4 illustrating a state in which the terminal is fastened.

### DETAILED DESCRIPTION OF THE PREFERRED EMBODIMENTS

Embodiments of a connection structure for a screw clamp terminal according to the present invention will be described in details below with reference to the figures. In the present embodiment, the connection structure for a screw clamp terminal is applied to terminal connection in an electrical junction box (fuse box) by way of example. The configuration of the electrical junction box is well known per se, and a specific description of the electrical junction box will be omitted.

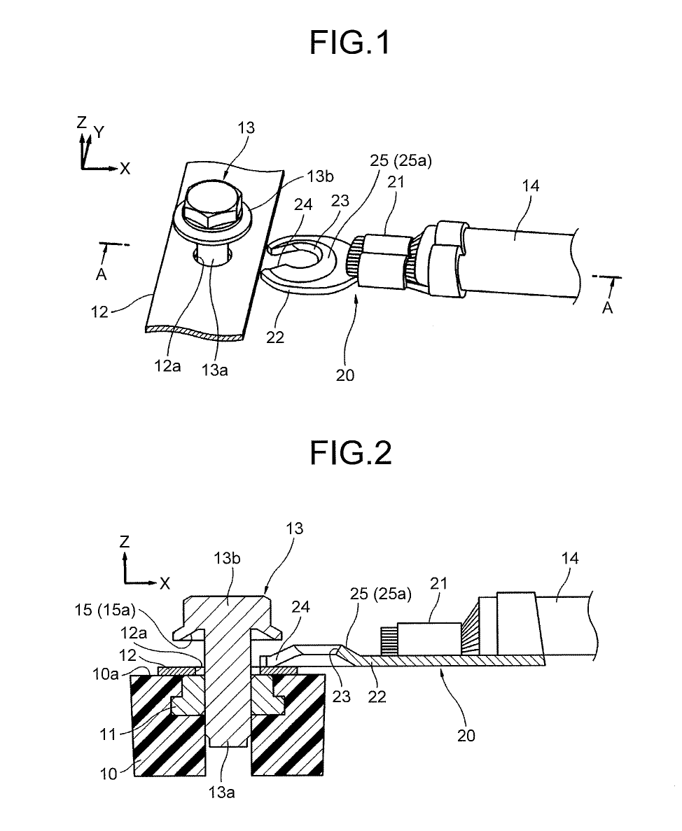

As illustrated in FIG. 1 and FIG. 2, a housing 10 of an electrical junction box is formed of an insulative resin material. A nut 11 is buried in the housing 10 such that the front end thereof faces a surface 10a in a state in which movement in the Z-axis direction and rotation around the Z-axis in the figures are restricted, that is, in a fixed state. A plate-shaped bus bar 12 serving as a member to be connected is arranged on the surface 10a of the housing 10. A hexagonal bolt (hereinafter simply referred to as “bolt”) 13 is screwed in the nut 11. The bolt 13 has a shaft 13a inserted into a through hole 12a provided in the bus bar 12 to fasten the bus bar 12 and a terminal 20 connected thereto.

An electric wire 14 is crimped to a well-known electric wire connection part 21 provided at the rear end side of the terminal 20. An electrical contact part 22 approximately in the shape of a letter C formed at the front end side of the terminal 20 is fastened to the bas bar 12 using the bolt 13 and the nut 11, thereby establishing electrical connection with the bus bar 12. The electrical contact part 22 has a bolt insertion hole 23 approximately at the center position thereof into which the shaft 13a of the bolt 13 can be inserted. The electrical contact part 22 has a notch 24 formed at the front end thereof so as to be cut along the longitudinal direction (the X-axis direction in the figures) of the terminal 20. The notch 24 provides direct communicative connection between the bolt insertion hole 23 and the outside to allow the bolt insertion hole 23 to be slipped onto the shaft 13a from the outside.

In the outer peripheral region of the bolt insertion hole 23 in the electrical contact part 22, an engagement projection 25 is provided, which is formed by deforming the hole edge of the bolt insertion hole 23 so as to push upward so that the hole edge of the bolt insertion hole 23 protrudes in the Z-axis positive direction in the figure. A convex conical surface 25a formed in a conical tapered shape is provided on the outer periphery of the engagement projection 25. On the inner surface of a head 13b of the bolt 13 that is opposed to the engagement projection 25 during the fastening of the electrical contact part 22 with the bus bar 12, an engagement depression 15 is provided, which has a concave conical surface 15a corresponding to the convex conical surface 25a and can be engaged with the engagement projection 25. As described above in the connection structure for the terminal 20 in the present embodiment, the engagement depression 15 and the engagement projection 25 can be engaged with each other during the fastening of the terminal 20 (the electrical contact part 22) and the bus bar 12 by the bolt 13 (see FIG. 4).

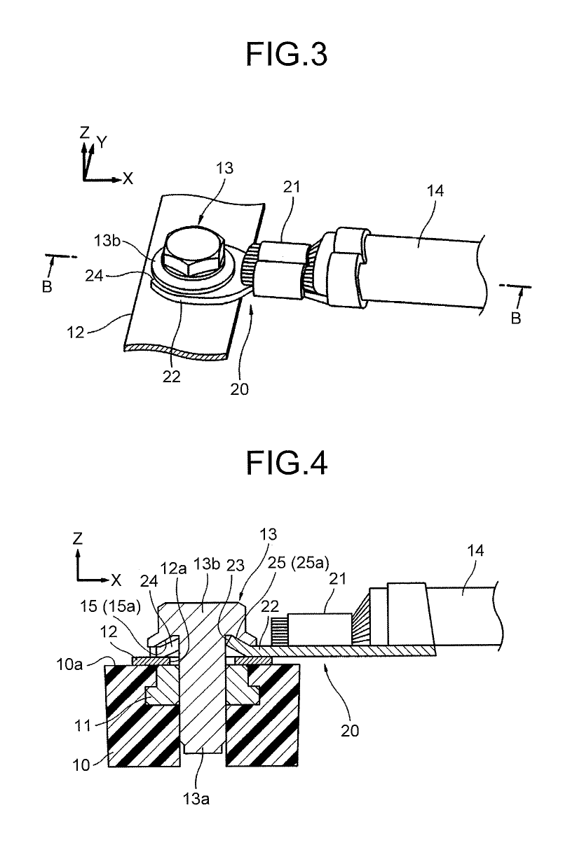

The connection procedure of the terminal 20 will be described below with reference to FIG. 1 to FIG. 4, and characteristic effects of the present invention will also be described. FIG. 1 and FIG. 2 illustrate a state before the terminal 20 is connected to the bus bar 12, and FIG. 3 and FIG. 4 illustrate a state after the terminal 20 is connected to the bus bar 12.

Specifically, to connect the terminal 20 to the bus bar 12, the terminal 20 having the electric wire 14 crimped thereto as described above is slipped along the longitudinal direction thereof (the X-axis direction in the figures) onto the shaft 13a of the bolt 13 inserted into the bus bar 12 disposed on the electrical junction box in advance and screwed into the nut 11 buried in the electrical junction box in advance. The shaft 13a is then engaged into the bolt insertion hole 23 through the notch 24.

The bolt 13 is tightened with a not-shown fastening tool such as an impact wrench, whereby the terminal 20 (the electrical contact part 22) and the bus bar 12 are fastened and connected with each other. Here, in the present embodiment, when the bolt 13 is tightened, the engagement depression 15 of the bolt 13 engages with the engagement projection 25 of the terminal 20, and this engagement structure brings about a wedge effect to allow the terminal 20 (the electrical contact part 22) to be gradually pulled toward the center of the bolt 13. This inevitably ensures connection with the bus bar 12 at an appropriate position even without positioning the terminal 20 as in the conventional example, thereby avoiding connection failure based on the fastening torque action. At the same time, the electrical contact part 22 is pushed down such that the head 13b of the bolt 13 suppresses enlargement of the notch 24 based on the wedge effect brought about by the engagement structure. Accordingly, expansion deformation of the electrical contact part 22 based on the fastening torque action, that is, enlargement deformation of the notch 24 as in the conventional example can also be suppressed.

As described above, in the connection structure for the terminal 20 according to the present embodiment, the engagement depression 15 of the bolt 13 is engaged with the engagement projection 25 of the terminal 20 during bolt fastening, so that connection failure based on the fastening torque action can be inevitably avoided, thereby achieving easy and reliable connection of the terminal 20.

In the present embodiment, the wedge effect also inevitably suppresses enlargement deformation of the notch 24 caused by the torque action during bolt fastening, thereby avoiding connection failure, detachment, and other inconvenience of the terminal 20 due to enlargement deformation of the notch 24.

Such a connection structure for the terminal 20 can be provided in such a simple configuration as merely providing the engagement projection 25 on the terminal 20 side and the engagement depression 15 on the bolt 13 side. Accordingly, the terminal 20 is unlikely to increase in size, and cost increase of the terminal 20 can be suppressed.

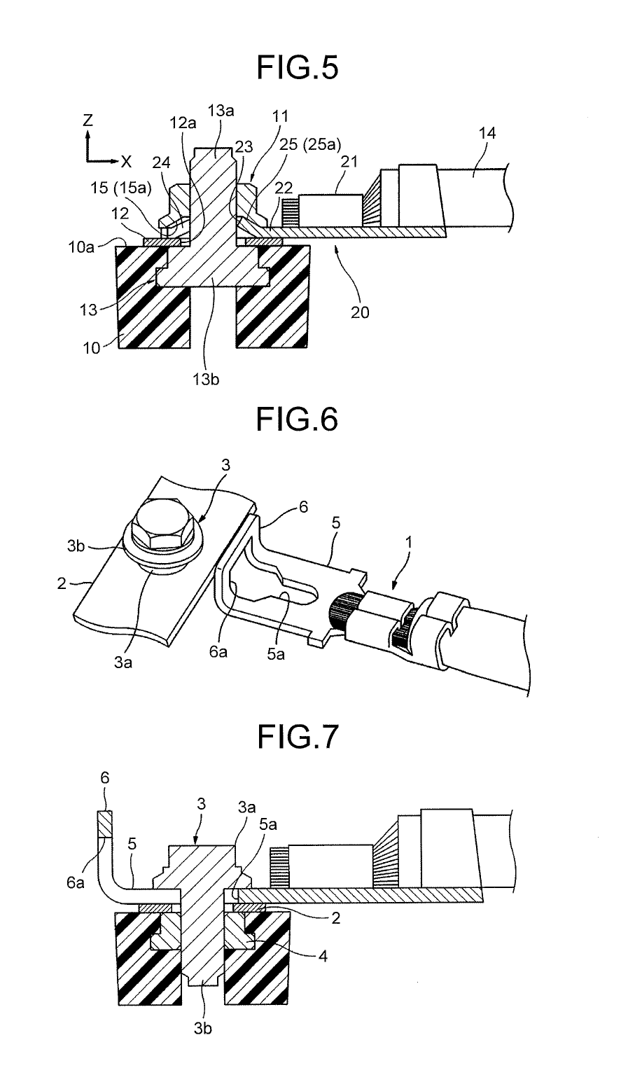

FIG. 5 illustrates a modification of the foregoing embodiment, in which the relation of arrangement between the bolt 13 and the nut 11 in the foregoing embodiment is reversed. In this modification, the configuration other than the relation of arrangement between the bolt 13 and the nut 11 is the same as the foregoing embodiment. The same configuration as the foregoing embodiment is therefore denoted with the same reference signs, and a specific description thereof will be omitted.

In this modification, the bolt 13 has its head 13b buried in the housing 10 of the electrical junction box and has the shaft 13a protruding from the surface 10a of the housing 10 toward the Z-axis positive direction in the figure and arranged so as to be inserted into the through hole 12a of the bus bar 12 arranged on the surface 10a of the housing 10. The nut 11 is screwed onto the front end of the shaft 13a. Also in this modification, the electrical contact part 22 of the terminal 20 having the electric wire 14 crimped thereto is slipped onto the shaft 13a exposed between the head 13b of the bolt 13 and the nut 11 through the notch 24, in the same manner as in the foregoing embodiment. The nut 11 is fastened to electrically connect the terminal 20 (the electrical contact part 22) with the bus bar 12.

Also in this modification, the electrical contact part 22 is pulled toward the center of the bolt 13 and pushed down so as to suppress enlargement of the notch 24 as the nut 11 is fastened (advanced) in the same manner as in the foregoing embodiment. As a result, the same operation effects as in the foregoing embodiment can be achieved.

The present invention is not limited to the configuration in the foregoing embodiment or other modifications. The configuration of details not directly pertinent to the configuration of the present invention, such as the configuration of details such as the terminal 20, the bolt 13, and the nut 11, for example, the shape of the bolt insertion hole 23 and the notch 24, as well as the parts directly pertinent to the configuration of the present invention, for example, such as the formation range of the engagement depression 15 and the engagement projection 25 and the angle of the conical surfaces 15a, 25a can be changed freely in accordance with the specifications or requirements of applications within a range that does not depart from the spirit of the invention.

According to the present invention, the terminal (electrical contact part) is pulled toward the bolt center as the bolt is fastened (advanced), so that connection at an appropriate position is inevitably ensured without performing positioning of the terminal.

Because of the engagement structure, the electrical contact part is also pushed down so as to suppress enlargement of the notch as the bolt is fastened (advanced), so that expansion deformation based on the fastening torque action on the electrical contact part, that is, enlargement deformation of the notch is suppressed, and connection failure, detachment, or other inconvenience of the terminal based on the deformation can be avoided.

The engagement structure can be provided in such a simple configuration as merely providing an engagement projection on the terminal side and an engagement depression on the bolt side, thereby suppressing not only size increase but also cost increase of the terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connection structure for a screw clamp terminal having an electrical contact part through which a bolt insertion hole penetratingly formed communicating with outside through a notch, a shaft of a bolt being inserted into the bolt insertion hole through the notch, a head of the bolt fastening the electrical contact part to a member to be connected to establish electrical connection, the connection structure comprising:
an engagement projection provided in an outer peripheral region of the bolt insertion hole, the engagement projection having a convex conical surface; and
an engagement depression provided on an inner surface of the head of the bolt and disposed opposed to the engagement projection, the engagement depression having a concave conical surface corresponding to the convex conical surface and being capable of engaging with the engagement projection through the concave conical surface, wherein
the engagement projection and the engagement depression are engaged with each other during fastening of the bolt.

2. A connection structure for a screw clamp terminal having an electrical contact part through which a bolt insertion hole penetratingly formed communicating with outside through a notch, a shaft of a bolt being inserted into the bolt insertion hole through the notch, a nut being screwed onto the shaft to fasten the electrical contact part to a member to be connected to establish electrical connection, the connection structure comprising:
an engagement projection provided in an outer peripheral region of the bolt insertion hole, the engagement projection having a convex conical surface; and
an engagement depression provided on an inner surface of the nut and disposed opposed to the engagement projection, the engagement depression having a concave conical surface corresponding to the convex conical surface and being capable of engaging with the engagement projection through the concave conical surface, wherein
the engagement projection and the engagement depression are engaged with each other during fastening of the nut.
